(19) United States
(12) Patent Application Publication
(10) Pub. No.: US 2019/0031031 A1
(43) Pub. Date: Jan. 31, 2019

(54) SYSTEMS, METHODS, AND APPARATUSES FOR IN FLIGHT MEASURING AND RECORDING TELEMETRY DATA OF A UAV

(71) Applicant: QUALCOMM Incorporated, San Diego, CA (US)

(72) Inventors: Joseph Oresko, San Diego, CA (US); Cody Wheeland, San Diego, CA (US); Vincent Kemler, San Diego, CA (US); Donald Bolden Hutson, San Diego, CA (US); Jason Peter Chan, San Diego, CA (US); Kevin Truong, San Diego, CA (US)

(21) Appl. No.: 15/665,198

(22) Filed: Jul. 31, 2017

(51) Int. Cl. B60L 3/12; H04Q 9/00

(52) U.S. Cl. CPC B60L 3/12; G08G 5/0013; H04Q 9/00

(57) ABSTRACT

Systems, methods, and apparatuses described herein relate to an embedded measurement (EM) system arranged on a robotic vehicle. The EM system includes a processor and at least one sensor operatively coupled to the processor. Each of the at least one sensor is embedded in a respective subsystem of the robotic vehicle to measure telemetry data thereof while the robotic vehicle is in transit.

### BACKGROUND

Telemetry data (e.g., power rail breakdown data, temperature, acceleration, orientation, and the like) can be useful for designing and analyzing robotic vehicles, such as unmanned aerial vehicles (UAVs) or drones. For example, the telemetry data (e.g., the power rail breakdown data for individual power rails or subsystems, temperature data for components, and the like) is used for analytics, such as but not limited to, thermal profiling, power transient profiling, correlation with flight characteristics, and the like. Traditionally, power rail breakdown data is measured by connecting the robotic vehicle with bench-top equipment (e.g., source meters, ammeters, etc.) via wires. In another example, temperature data is traditionally measured by coupling the robotic vehicle with a thermocouple that is linked, via wires, to an Analog-to-Digital Converter (ADC). Wired connections to bench-top test equipment prohibit the robotic vehicle from moving (e.g., flying) while being tested, thus severely limiting aspects of the robotic vehicle that can be tested. In addition, the bench-top equipment is typically connected to large, external Data Acquisition (DAQ) units, which further encumber the data gathering. Still further, tethered options involve long cables or wires, which can result in adverse additional weight and signal noise.

### SUMMARY

In some implementation, an embedded measurement (EM) system arranged on a robotic vehicle, includes a processor and at least one sensor operatively coupled to the processor, each of the at least one sensor is embedded in a respective subsystem of the robotic vehicle to measure telemetry data thereof while the robotic vehicle is in transit.

In some implementations, the telemetry data includes one or more of power rail breakdown data, temperature, acceleration, or orientation.

In some implementations, the at least one sensor includes at least one first sense resister in series with a power rail of a first subsystem to measure power rail breakdown data of the first subsystem while the robotic vehicle is in transit.

In some implementations, the EM system further includes a first differential ADC operatively coupled to the at least one first sense resister to measure voltage drop across the at least one first sense resistor.

In some implementations, the at least one sensor includes at least one second sense resister in series with a power rail of a second subsystem to measure power rail breakdown data of the second subsystem while the robotic vehicle is in transit.

In some implementations, the EM system further includes a second differential ADC operatively coupled to the at least one second sense resister to measure voltage drop across the at least one second sense resistor.

In some implementations, the at least one sensor includes at least one thermocouple operatively coupled to a component of a subsystem of the robotic vehicle to measure temperature of the component while the robotic vehicle is in transit.

In some implementations, the robotic vehicle is an unmanned aerial vehicle (UAV), and the telemetry data is measured while the UAV is in flight.

In some implementations, the processing circuit of the EM is separate from a robotic vehicle processing circuit, wherein the robotic vehicle processing circuit is configured to control at least one of power or movement of the robotic vehicle.

In some implementations, the processing circuit of the EM is operatively, via a communication bus, to the robotic vehicle processing circuit to provide the telemetry data to the robotic vehicle processing circuit for the robotic vehicle processing circuit to account for the telemetry data while the robotic vehicle is in transit.

In some implementations, the telemetry data is synchronized between the processing circuit of the EM and the robotic vehicle processing circuit using one or more of timestamps, sequence numbers, or markers.

In some implementations, the processing circuit of the EM is operatively coupled to the robotic vehicle processing circuit to transmit the telemetry data to a base station in real-time using a network device operatively coupled to the robotic vehicle processing circuit.

In some implementations, the EM system further includes a memory interface configured to receive a portable memory device, wherein the processing circuit of the EM is configured to write the telemetry data to the portable memory device.

In some implementations, the at least one sensor further includes an acceleration sensor embedded in a subsystem to measure acceleration of the fourth subsystem.

In some implementations, the at least one sensor further includes an orientation sensor embedded in a subsystem to measure orientation of the fourth subsystem.

In some implementations, the respective subsystem includes two or more of a navigation subsystem, a flight control subsystem, a communication subsystem, a power subsystem, a camera subsystem, or an application processing subsystem.

In various implementations, a robotic vehicle includes a robotic vehicle processing circuit that includes a robotic vehicle processor and a robotic vehicle memory, two or more subsystems, and an EM system that includes at least one sensor, each of the at least one sensor is embedded in one of the two or more subsystems to measure telemetry data of the one of the two or more subsystems, a processing circuit, includes a processor operatively coupled to the at least one sensor to collect the telemetry data, and a memory operatively coupled to the processor. The EM is configured to measure the telemetry data while the robotic vehicle is in transit.

In some implementations, the at least one sensor includes at least one first sense resister in series with a power rail of a first subsystem of the two or more subsystems to measure power rail breakdown data of the first subsystem while the robotic vehicle is in transit. The EM system further includes a first differential ADC operatively coupled to the at least one first sense resister to measure voltage drop across the at least one first sense resistor.

In some implementations, the at least one sensor includes at least one second sense resister in series with a power rail of a second subsystem of the two or more subsystems to measure power rail breakdown data of the second subsystem while the robotic vehicle is in transit. The EM system further includes a second differential ADC operatively coupled to the at least one second sense resister to measure voltage drop across the at least one second sense resistor.

In some implementations, the at least one sensor includes at least one thermocouple operatively coupled to a component of a third subsystem of the robotic vehicle to measure temperature of the component while the robotic vehicle is in transit.

In some implementations, the at least one sensor further includes an acceleration sensor embedded in a fourth subsystem of the two or more subsystems to measure acceleration of the fourth subsystem.

In some implementations, the at least one sensor further includes an orientation sensor embedded in a fifth subsystem of the two or more subsystems to measure orientation of the fifth subsystem.

In some implementations, the processing circuit of the EM is operatively coupled, via a communication bus, to the robotic vehicle processing circuit to provide the telemetry data to the robotic vehicle processing circuit for the robotic vehicle processing circuit to account for the telemetry data while the robotic vehicle is in transit.

In some implementations, the telemetry data is synchronized between the processing circuit of the EM and the robotic vehicle processing circuit using one or more of timestamps, sequence numbers, or markers.

In some implementations, the processing circuit of the EM is operatively coupled to the robotic vehicle processing circuit to transmit the telemetry data to a base station in real-time using a network device operatively coupled to the robotic vehicle processing circuit.

In some implementations, the two or more subsystems include two or more of a navigation subsystem, a flight control subsystem, a communication subsystem, a power subsystem, a camera subsystem, or an application processing subsystem.

In some implementations, the robotic vehicle processing circuit is configured to control at least one of the two or more subsystems.

In various implementations, an EM system arranged on a robotic vehicle includes sensor means embedded in one of two or more subsystems of the robotic vehicle to measure telemetry data of the one of the two or more subsystems, a processing circuit means that includes a processing means operatively coupled to the sensor means to collect the telemetry data and a memory means operatively coupled to the processing means. The EM is configured to measure the telemetry data while the robotic vehicle is in transit.

In some implementations, a method for measuring telemetry data of a robotic vehicle using an EM system includes measuring, with at least one sensor, the telemetry data of one of the two or more subsystems of the robotic vehicle, wherein the at least one sensor is embedded in the one of two or more subsystems, collecting, by a processing circuit of the EM system, the telemetry data, buffering, by the processing circuit, the telemetry data, and sending, by the processing circuit via a communication bus, the telemetry data to a robotic vehicle processing circuit.

### BRIEF DESCRIPTION OF THE DRAWINGS

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well-known structures and components are shown in block diagram form in order to avoid obscuring such concepts.

FIG. 1 is a schematic diagram illustrating an unmanned aerial vehicle (UAV) with an embedded measurement (EM) system according to some implementations.

FIG. 2 is a schematic diagram illustrating the UAV (FIG. 1) having the EM system (FIG. 1) according to some implementations.

FIG. 3 is a schematic diagram illustrating the UAV (FIG. 1) having the EM system (FIGS. 1 and 2) according to some implementations.

FIG. 4A is a flow diagram illustrating a method for measuring telemetry data using an EM system according to some implementations.

FIG. 4B is a flow diagram illustrating a method for measuring telemetry data using an EM system according to some implementations.

### DETAILED DESCRIPTION

Arrangements described herein relate to an embedded measurement (EM) system arranged on a robotic vehicle (e.g., an unmanned aerial vehicle (UAV)) to measure telemetry data while the robotic vehicle is in transit (e.g., while the robotic vehicle is in flight), thus eliminating wired connections to bench-top equipment. In particular, the EM system may include various sensors embedded in one or more subsystems of the robotic vehicle. The embedded sensors may be lightweight and can be carried by the robotic vehicle, to measure the telemetry data regardless of while the robotic vehicle is in transit or while the robotic vehicle is stationary. Example telemetry data can be one or more of power rail breakdown data (e.g., power drop/draw data), temperature, acceleration, orientation, and the like.

In some arrangements, the EM system may include a dedicated processing circuit (including at least a dedicated EM processor and at least a dedicated EM memory) arranged on the robotic vehicle and can be in transit (e.g., fly) with the robotic vehicle. In some arrangements, the robotic vehicle may include at least one processing circuit separate from the dedicated EM processing circuit. The at least one separate processing circuit may be any processing circuit arranged on the robotic vehicle that is not the dedicated EM processing circuit. The at least one separate processing circuit may be configured to control power, movement (e.g., flight), communications, and/or other suitable subsystems of the robotic vehicle.

Relative to measuring power rail breakdown data, the EM system may include one or more sense resistors embedded in series with a power rail of the robotic vehicle in some arrangements. The voltage drop across each of the sense resistors may be measured using a differential Analog-to-Digital Converter (ADC). The differential ADC may be connected to the dedicated EM processing circuit. The EM processing circuit may collect the power rail breakdown data and buffer such data. Similarly, the EM system can measure other telemetry data, such as, but not limited to, temperature, acceleration, orientation, and the like by providing corresponding embedded sensors on the robotic vehicle.

In some arrangements, one or more of the at least one separate processing circuit may be connected to the EM system via a communication bus, such that the EM system may provide the collected telemetry data to the at least one separate processor and the at least one separate memory. The at least one separate processor and the at least one separate memory can use the telemetry data for movement (e.g., flight control), analytics, and the like. In some arrangements, the EM system can support up to 64 channels of telemetry data. In some arrangements, smaller versions of the EM system can support fewer than 64 channels, or larger versions of the EM system can support greater than 64 channels.

By providing embedded sensors (e.g., a sense resistor in series with each power rail as described herein), telemetry data (e.g., power rail breakdown for each power rail) can be obtained while the drone is either in transit or stationary. Accordingly, the robotic vehicle is no longer restricted to being cabled or tethered to benchtop equipment for testing or monitoring. This allows the robotic vehicle to move freely, thus increasing aspects and parameters of the robotic vehicle that can be measured, and increases the accuracy of the measurements. The EM system may not require any re-calibration, once initially calibrated. Thus, docking the robotic vehicle for benchtop calibration may be avoided. In some arrangements, EM system can be used on the bench as well, and the EM system may not prohibit benchtop methods of measuring. For example, the sensors associated with the EM system can be connected to benchtop equipment.

The power consumed by the EM system may be low (negligible compared to power consumed by motors). The EM system may be light-weight compared to traditional benchtop equipment, such that the movement (e.g., flight) of the robotic vehicle is not affected. In some arrangements, the EM system may write the telemetry data to a Secure Digital (SD) card or local flash memory, allowing the EM system to operate independently from the memory of the robotic vehicle.

In some arrangements, the EM system may connect to the at least one separate processing circuit and may use the separate processing circuit's wireless link to transmit the telemetry data to a base station in real-time. In some arrangements, the EM firmware image can be reprogrammed, in flight, for updates. In some arrangements, the EM system can use timestamp, markers, and/or sequence numbers with respect to the telemetry data to synchronize the telemetry data with one or more of the at least one separate processing circuit. This allows convenient post-processing of the telemetry data that may correlate with behaviors (e.g., flight characteristics). In some arrangements, the EM system can function as a health/failure monitor to detect abnormal current consumption and feed such information back into the control system executed by the separate processing circuit. The control system or an operator of the robotic vehicle can take further action based on the warnings. In some arrangements, the EM system can serve as a redundant environmental monitor, in the event that a host application monitor provided by the at least one separate processing circuit becomes inoperable (e.g., locked up).

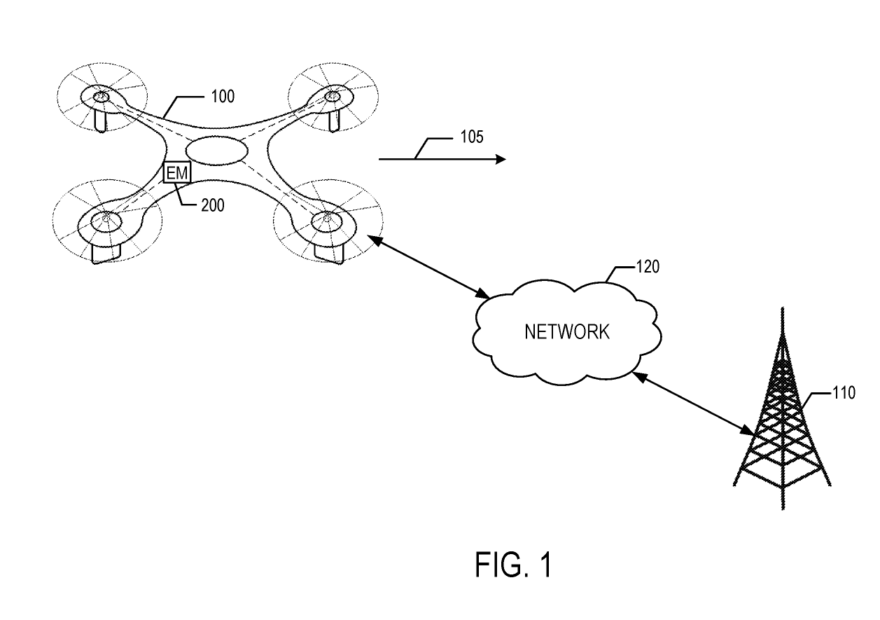

FIG. 1 is a schematic diagram illustrating an unmanned aerial vehicle (UAV) 100 that is in flight according to some implementations. While UAVs are described herein, one of ordinary skill in the art can appreciate that the disclosed arrangements can be likewise implemented on other suitable types of robotic vehicles, such as but not limited to, unmanned surface vehicles (USVs), unmanned marine vehicles (UMVs), and the like. In some arrangements, the UAVs described herein refers to small-scaled, non-military UAVs. In other arrangements, the UAV described herein refers to any suitable types of UAVs. As shown in FIG. 1, the UAV 100 may be of a “quad-copter” configuration. In an example quad-copter configuration, four horizontally configured rotary lift propellers and motors may be fixed to a frame. In other example configurations, more or fewer rotary lift propellers/motors may be employed. The propellers may generate a lifting force sufficient to lift the UAV 100, including the structure, motors, rotors, electronics, power source, loads, an EM system 200, and the like. As shown, the UAV 100 may be in flight, and may be moving in any arbitrary direction 105. In other examples, the UAV 100 may be hovering in place.

The motors may be powered by an electrical power source such as a battery. Alternatively, the UAV 100 may have one or more fuel-controlled motors, such as but not limited to one or more internal combustion motors. While the present disclosure is directed to examples of electric motor controlled UAVs, the concepts disclosed herein may be applied equally to UAVs powered by virtually any power source. The rotary lift propellers/motors may be vertical or horizontally mounted depending on a flight mode of the UAV 100.

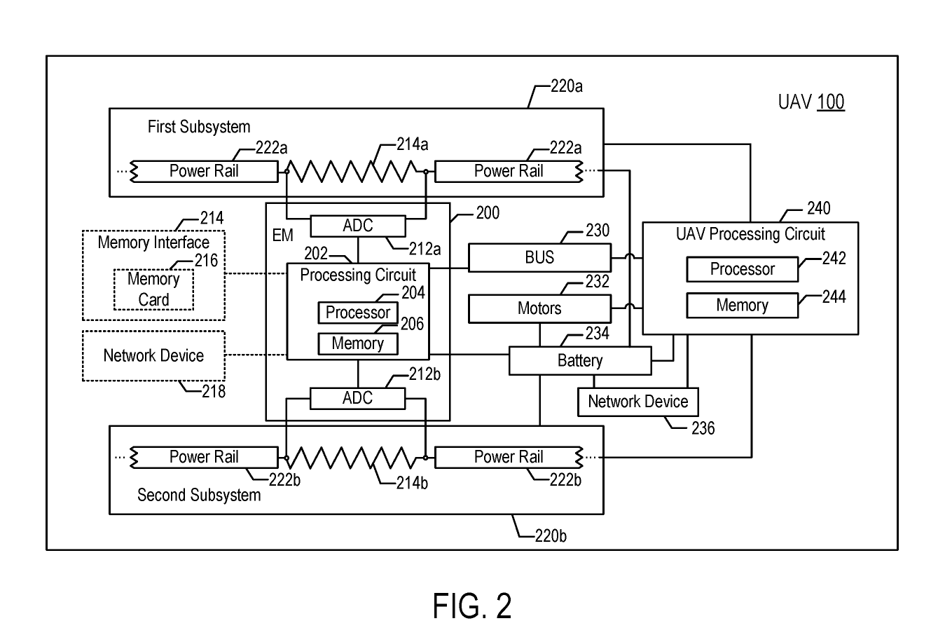

Typically, the UAV 100 may be configured with one or more processing circuits (e.g., a robotic vehicle processing circuit, such as but not limited to, a UAV processing circuit 240 of FIG. 2) that enable navigation, such as by controlling the flight motors to achieve flight speed and directionality. The UAV 100 may be configured with one or more communication/network devices configured to receive position information and information from beacons, servers, access points, controllers, and other devices. The position information may be associated with the current position, waypoints, flight paths, avoidance paths, altitudes, destination locations, locations of charging stations, and the like. For ease of description and illustration, some detailed aspects of the UAV 100, such as wiring, frame structure, or other features known to one of ordinary skill in the art are omitted.

The UAV 100 may be in communication with a base station 110 via a network 120. The base station 110 may be a wireless communication device, such as but not limited to a beacon, server, smartphone, tablet, controller, or another device with which the UAV 100 may be in communication. In some arrangements, the base station 110 may be a device used by an operator to control various aspects (e.g., flight, sensors, cameras, and the like) of the UAV 100. In that regard, the base station 110 may send control command signals to the UAV 100. In some arrangements, the base station 110 may receive data (e.g., telemetry data, photographs, videos, other suitable sensor data, and the like) from the UAV 100. In some arrangements, the base station 110 may be a cellular network base station, a cell tower radio, a network node, a Wi-Fi access point, a radio station, or the like configured to relate signals (e.g. the control command signals) or data (e.g., the telemetry data, photographs, videos, other suitable sensor data, and the like) to and/or from the UAV 100. In that regard, the UAV 100 may be configured to support multiple connections with different base stations supporting different Radio Access Technologies (RATs). In some arrangements, the base station 110 may be connected to a server or may provide access to the server. For instance, the base station 110 may be a server of a UAV operator, a third party service (e.g., package delivery, billing, etc.), or an operator of an area. In that regard, the UAV 100 may communicate with the server through an intermediate communication link such as one or more network nodes or other communication devices. In some arrangements, the base station 110 may be a beacon that controls access to an area.

The network 120 may be any suitable Wireless Local Area Network (WLAN), Wireless Wide Area Network (WWAN), Wireless Personal Area Network (WPAN), or a combination thereof. For example, the network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network 120 may be structured to permit the exchange of data, signals, values, instructions, messages, and the like between the UAV 100 and the base station 110.

FIG. 2 is a schematic diagram illustrating the UAV 100 (FIG. 1) having the EM system 200 (FIG. 1) according to some implementations. Referring to FIGS. 1-2, the UAV 100 may have one or more processing circuits (such as but not limited to the UAV processing circuit 240) that control various subsystems (such as but not limited to subsystems 220a and 220b). For instance, the UAV processing circuit 240 may be operatively coupled to the first subsystem 220a and the second subsystem 220b to control the first subsystem 220a and the second subsystem 220b, respectively. While the single UAV processing circuit 240 is shown in FIG. 2, one of ordinary skill in the art can appreciate that the UAV processing circuit 240 may represent one or multiple processing circuits that control the various subsystems of the UAV 100 as described herein. While the UAV processing circuit 240 is shown to be separate from the subsystems 220a and 220b, one of ordinary skill in the art can appreciate that the UAV processing circuit 240 may be a part of one or more of the subsystems 220a and 220b. One or more of the subsystems 220a and 220b may have a dedicated processing circuit, which is represented by the processing circuit 240 for the sake of clarity.

The UAV processing circuit 240 may include a robotic vehicle processor and a robotic vehicle memory such as but not limited to, a processor 242 and memory 244, respectively. The processor 242 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 244 (e.g., Random Access Memory (RAM), Read-Only Memory (ROM), Non-volatile RAM (NVRAM), Flash Memory, hard disk storage, etc.) may store data and/or computer code for facilitating at least some of the various processes described herein. The memory 244 may include tangible, non-transient volatile memory, or non-volatile memory. In this regard, the memory 244 may store programming logic that, when executed by the processor 242, controls the operations of the subsystems 220a and 220b.

Examples of each of the subsystems 220a and 220b may include but are not limited to a navigation subsystem, flight control subsystem, communication subsystem, power subsystem, camera subsystem, application processing subsystem, and the like.

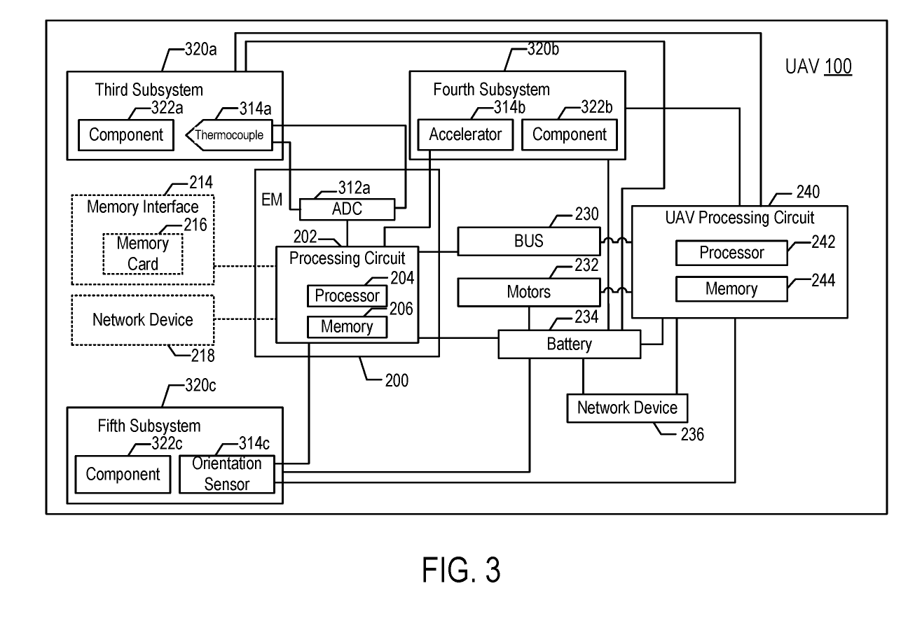

In some arrangements, the navigation subsystem may be configured to provide flight control-related information such as altitude, attitude, airspeed, heading and similar information that the UAV processing circuit 240 may use for navigation purposes, such as dead reckoning between Global Navigation Satellite System (GNSS) position updates. In some examples, the navigation subsystem may include a GNSS receiver system (e.g., one or more (Global Positioning System) GPS receivers) enabling the UAV 100 to navigate using GNSS signals, and the radio navigation receivers for receiving navigation beacon or other signals from radio nodes, such as navigation beacons (e.g., Very High Frequency (VHF) Omni Directional Radio Range (VOR) beacons), Wi-Fi access points, cellular network sites, radio station, and the like. A network device 236 may be configured to communicate with a server (e.g., the base station 110) through the network 120 to receive data useful in navigation as well as to provide real-time position reports. The navigation subsystem may include or receive data from a gyro/accelerometer unit (e.g., the accelerometer 314b of FIG. 3, the orientation sensor 314c of FIG. 3, and the like) that may provide data regarding the orientation and accelerations of the UAV 100 that may be used in navigation calculations.

In some arrangements, the flight control subsystem may be operatively coupled to the motors 232 to control the individual motors 232, in order to control flight of the UAV 100. In some examples, the navigation subsystem may send data to the UAV processing circuit 240, which may use such data to determine the present position and orientation of the UAV 100, as well as the appropriate course towards the destination. The flight control subsystem may control the motors 232 accordingly. In some arrangements, the motors 232 may be a subsystem or may be a part of a subsystem (e.g., the flight control subsystem).

The communication subsystem may be configured to receive navigation signals, such as beacon signals, signals from aviation navigation facilities, command control signals from the base station 110, and the like. The communication subsystem may provide such signals to the UAV processing circuit 240 and/or the navigation subsystem to assist in navigation of the UAV 100. In some arrangements, a network device 236 may be the communication subsystem. While the network device 236 is shown to be separate from the subsystems 220a and 220b, one of ordinary skill in the art can appreciate that the network device 236 can be likewise treated as one of the subsystems 220a and 220b. For example, the communication subsystem or the network device 236 may receive signals from recognizable Radio Frequency (RF) emitters (e.g., AM/FM radio stations, Wi-Fi access points, cellular network base stations, etc.) of the base station 110 on the ground. In that regard, the communication subsystem or the network device 236 may include at least one transceiver that performs transmit/receive functions for the UAV 100 in the manner described herein. The communication subsystem or the network device 236 may include separate transmit and receive circuitry, or may include a transceiver that combines transmitter and receiver functions. The communication subsystem or the network device 236 may include or otherwise may couple to a wireless antenna.

In some examples, the communication subsystem or the network device 236 may be configured to switch between a WWAN, a WLAN, or a WPAN connection depending on the location and altitude of the UAV 100. For example, while in flight at an altitude designated for UAV traffic, the communication subsystem or the network device 236 may communicate with a cellular infrastructure in order to maintain communications with the base station 110. An example of a flight altitude for the UAV 100 may be at around 400 feet or less, as designated by a government authority (e.g., Federal Aviation Authority (FAA)) for UAV flight traffic. At this altitude, it may be difficult to establish communication using short-range radio communication links (e.g., Wi-Fi). Therefore, cellular telephone networks may be used for communication while the UAV 100 is at flight altitude. Communication between the communication subsystem and the base station 110 may transition to a short-range communication link (e.g., Wi-Fi or Bluetooth) when the UAV 100 moves closer to the base station 110.

In some arrangements, the power subsystem may include an electrical power source such as a battery. In some examples, the UAV processing circuit 240 may control charging and power distribution of power stored in the power subsystem. In some arrangements, a battery 234 may be a power subsystem, although the battery 234 and the subsystems 220a and 220b may be shown to be separate components. The power subsystem or the battery 234 may be operatively coupled to the UAV processing circuit 240, the network device 236, the motor 232, and a processing circuit 202 of an EM 200 to provide power thereto. In some examples, the power subsystem or the battery 234 may be operatively coupled to one or more of the subsystems (e.g., the subsystems 220a and 220b) of the UAV 100 to provide power thereto, if needed.

In some arrangements, the camera subsystem may include camera (e.g., a stereo camera, an infrared camera, a high-definition camera, or another suitable camera) supported by a support structure. The support structure may be fixed or otherwise attached to the frame of the UAV 100. The support structure may include a camera gimbal movable by one or more motors to move the camera. The support structure may include various vibration dampening elements (e.g., flexible paddings, springs, and/or the like) to isolate vibrations. Other sensor subsystems may be similarly implemented.

In some arrangements, the application processing subsystem may include or otherwise may couple to a processing circuit (e.g., the UAV processing circuit 240) for executing suitable application functions enabled for the UAV 100.

In some arrangements, the EM system 200 may be arranged on the UAV 100 such that the EM system 200 can fly with the UAV 100 to measure the telemetry data associated with the UAV 100 while the UAV 100 is in flight. The EM system 200 may include the processing circuit 202. The processing circuit 202 may include a processor 204 and memory 206. The processor 204 may be implemented as a general-purpose processor, an ASIC, one or more FPGAs, a DSP, a group of processing components, or other suitable electronic processing components. The memory 206 (e.g., RAM, ROM, NVRAM, Flash Memory, hard disk storage, etc.) may store data and/or computer code for facilitating at least some of the various processes described herein. The memory 206 may include tangible, non-transient volatile memory, or non-volatile memory. In this regard, the memory 206 may store programming logic that, when executed by the processor 204, collects and buffers telemetry data obtained with respect to one or more subsystems of the UAV 100. As shown, the EM system 200 may have a dedicated EM processing circuit 202 separate from the UAV processing circuit 240. As such, telemetry data collection and buffering may be executed with the dedicated EM processing circuit 202.

The first subsystem 220a may include a power rail 222a. The power rail 222a may be configured to direct power drawn from the battery 234 or another suitable power source throughout the first subsystem 220a for power needs of the first subsystem 220a. For example, the power rail 222a may be operatively coupled to the battery 234 on one end to draw power from the battery 234. The power rail 222a may be operatively coupled to ground or a power rail (e.g., a power rail 222b) of another subsystem (e.g., the subsystem 220b). The power rail 222a may be operatively coupled to components (not shown for clarity) of the first subsystem 220a to provide power to the components. The EM system 200 may include a sense resistor 214a embedded within the first subsystem 220a. In particular, the sense resistor 214a may be placed in series with the power rail 222a such that a current carried by the power rail 222a may also pass through the sense resistor 214a. A differential ADC 212a may be configured to measure the voltage drop across the sense resistor 214a, to obtain the power rail breakdown data with respect to the power rail 222a of the first subsystem 220a. While one sense resistor 214a is shown to be embedded in the first subsystem 220a, one of ordinary skill in the art can appreciate that at least one additional sense resistor (such as but not limited to the sense resistor 214a) may be embedded in the same power rail 222a or another power rail of the first subsystem 220a to measure the power rail breakdown data of the first subsystem 220a.

The EM system 200 may be configured to measure the power rail breakdown data of another subsystem of the UAV 100. For examples, the second subsystem 220b may include a power rail 222b. The power rail 222b may be configured to direct power drawn from the battery 234 or another suitable power source throughout the second subsystem 220b for power needs of the second subsystem 220b. For example, the power rail 222b may be operatively coupled to the battery 234 on one end to draw power from the battery 234. The power rail 222b may be operatively coupled to ground or a power rail (e.g., the power rail 222a) of another subsystem (e.g., the subsystem 220a). The power rail 222b may be operatively coupled to components (not shown for clarity) of the second subsystem 220b to provide power to the components. The EM system 200 may include a sense resistor 214b embedded within the second subsystem 220b. In particular, the sense resistor 214b may be placed in series with the power rail 222b such that a current carried by the power rail 222b may also pass through the sense resistor 214b. A differential ADC 212b may be configured to measure the voltage drop across the sense resistor 214b, to obtain the power rail breakdown data with respect to the power rail 222b of the second subsystem 220b. While one sense resistor 214b is shown to be embedded in the second subsystem 220b, one of ordinary skill in the art can appreciate that at least one additional sense resistor (such as but not limited to the sense resistor 214b) may be embedded in the same power rail 222b or another power rail of the second subsystem 220b to measure the power rail breakdown data of the second subsystem 220b.

Examples of each of the sense resistors 214a and 214b may include but are not limited to a 0.005Ω resistor, a 0.001Ω resistor, a 0.0005Ω resistor, and the like.

In some arrangements, in addition to measuring the power rail breakdown data of the subsystems 220a and 220b, the EM system 200 may alternatively or additional collect other types of telemetry data. FIG. 3 is a schematic diagram illustrating the UAV 100 (FIG. 1) having the EM system 200 (FIGS. 1 and 2) according to some implementations. Referring to FIGS. 1-3, the UAV 100 may include the one or more processing circuits (such as but not limited to the UAV processing circuit 240) that control various subsystems (such as but not limited to subsystems 320a, 320b, and 320c). While the single UAV processing circuit 240 is shown in FIG. 3, one of ordinary skill in the art can appreciate that the UAV processing circuit 240 may represent one or multiple processing circuits that control the various subsystems of the UAV 100 as described herein. One or more of the subsystems 320a, 320b, and 320c may have a dedicated processing circuit, which is represented by the processing circuit 240 for the sake of clarity.

In some arrangements, one or more of the subsystems 320a, 320b, and 320c may be one or more of the subsystems 220a and 220b. In that regard, the EM system 200 may measure the power rail breakdown data as well as at least one other type of telemetry data (e.g., temperature, acceleration, orientation, and the like) with respect to one of the subsystems 220a, 220b, 320a, 320b, and 320c.

For instance, the UAV processing circuit 240 may be operatively coupled to the third subsystem 320a, the fourth subsystem 320b, and the fifth subsystem 320c to control the third subsystem 320a, the fourth subsystem 320b, and the fifth subsystem 320c, respectively. While the single UAV processing circuit 240 is shown in FIG. 3, one of ordinary skill in the art can appreciate that the UAV processing circuit 240 may represent one or multiple processing circuits that control the various subsystems of the UAV 100. While the UAV processing circuit 240 is shown to be separate from the subsystems 320a, 320b, and 320c, one of ordinary skill in the art can appreciate that the UAV processing circuit 240 may be a part of one or more of the subsystems 320a, 320b, and 320c.

Examples of each of the subsystems 320a, 320b, and 320c may include but are not limited to a navigation subsystem, flight control subsystem, communication subsystem, power subsystem, camera subsystem, application processing subsystem, and the like. In further arrangements, each of the subsystems 320a, 320b, and 320c may be the UAV processing circuit 240, the network device 236, the battery 234, the motor 232, and the like.

The third subsystem 320a may include a component 322a. The component 322a may be a heat-generating electronic component (e.g., a chip implementing the UAV processing circuit 240, a chip implementing the network device 236, one or more of the motors 232, and the like). The EM system 200 may include a thermocouple 314a embedded in the third subsystem 320a to measure a temperature of the component 322a. A differential ADC 312a may be configured to measure the voltage drop across the thermocouple 314a, to obtain the temperature data with respect to the third subsystem 320a. In some arrangements, the component 322a (e.g., a chip) of the UAV 100 may include one or more internal built-in temperature sensors. In such arrangements, the thermocouple 314a may represent an additional, external temperature sensor for the component 322a.

While one thermocouple 314a is shown to be embedded in the third subsystem 320a, one of ordinary skill in the art can appreciate that at least one additional thermocouple (such as but not limited to the thermocouple 314a) may be embedded in the third subsystem 320a to measure the temperature of the same component 322a or another component of the third subsystem 320a. In a similar manner, one or more thermocouples may be embedded in other subsystems of the UAV 100 to measure the temperature of one or more other components of the other subsystems.

The fourth subsystem 320b may include any suitable component 322b. For example, the component 322b may be an electronic component or a part of a support structure of the UAV 100. The EM system 200 may include an accelerometer 314b embedded in the fourth subsystem 320b to measure acceleration of the fourth subsystem 320b and the component 322b. While one accelerometer 314b is shown to be embedded in the fourth subsystem 320b, one of ordinary skill in the art can appreciate that at least one additional accelerometer (such as but not limited to the accelerometer 314b) may be embedded in the fourth subsystem 320b to measure the acceleration of the same component 322b or another component of the fourth subsystem 320b. In a similar manner, one or more accelerometers may be embedded in other subsystems of the UAV 100 or other portions of the UAV 100 to measure the acceleration associated therewith.

The fifth subsystem 320c may include any suitable component 322c. For example, the component 322c may be an electronic component or a part of a support structure of the UAV 100. The EM system 200 may include an orientation sensor 314c (e.g., one or more gyroscopes, one or more accelerometers, a combination of at least one gyroscope and at least one accelerometer, and the like) embedded in the fifth subsystem 320c to measure orientation of the fifth subsystem 320c and the component 322c. While one orientation sensor 314c is shown to be embedded in the fifth subsystem 320c, one of ordinary skill in the art can appreciate that at least one additional orientation sensor (such as but not limited to the orientation sensor 314c) may be embedded in the fifth subsystem 320c to measure the orientation of the same component 322c or another component of the fifth subsystem 320c. In a similar manner, one or more orientation sensors may be embedded in other subsystems of the UAV 100 or other portions of the UAV 100 to measure the orientation associated therewith.

In some arrangements, the EM system 200 may be lightweight and can fly with the UAV 100 without cables and without tethering to measure the telemetry data while the UAV 100 is in flight. The EM system 200 (including telemetry data sensors such as the sense resistors 214a and 214b, the ADCs 212a, 212b, and 312a, the thermocouple 314a, the accelerometer 314b, the orientation sensor 314c, and the processing circuit 202) may weigh only a few grams. The EM system 200 may be associated with low power consumption. The power consumption of the EM system 200 may be negligible as compared to that of the motors 232.

In some arrangements, the EM system 200 (e.g., the processing circuit 202) may be operatively coupled to a memory interface 214 which can receive a memory card 216, such as not limited to a SD card or local flash memory. The processing circuit 202 may write the telemetry data (obtained via one or more of the sensors 214a, 214b, 314a, 314b, and 314c) to the memory card. In that regard, the memory card 216 may function as a black box, storing the telemetry data that can be used to determine causes (e.g., power outages, overheating, and the like) for UAV failure. Using the memory card 216 as a black box in the context of the EM system 200 can be advantageous over traditional black boxes given that the EM system 200 includes embedded sensors with short or no wires. Traditional black boxes may include long cables, which may deprive valuable space on the UAV 100 and add additional weight.

In some arrangements, the UAV processing circuit 240 may be operatively coupled to the EM system 200 (e.g., the processing circuit 202) via a bus 230 to fetch the telemetry data collected and buffered by the EM system 200. In some arrangements, the telemetry data corresponding to each sensor (e.g., the sensors 214a, 214b, 314a, 314b, and 314c) may be outputted on a separate channel. In some arrangements, the EM system 200 can support up to 64 channels. In other arrangements in which a smaller version of the EM system 200 is employed, fewer than 64 channels can be supported.

In some arrangements, the UAV processing circuit 240 may use the telemetry data (e.g., the orientation data, the acceleration data, the temperature data, and the like) determined using the EM system 200 as basis for analyzing methods to optimize weight and thermal mitigation solutions on the UAV 100. In other words, the telemetry data measured while the UAV 100 is in flight can be raw data used by a design engineer for optimizing the design of the UAV 100.

In some arrangements, the UAV processing circuit 240 may use the telemetry data for real-time flight control. Illustrating with a non-limiting example, the UAV processing circuit 240 may receive the telemetry data from the processing circuit 202 via the bus 230. Responsive to the UAV processing circuit 240 determining that acceleration of the UAV 100 and/or a subsystem thereof (e.g., acceleration of the fourth subsystem 320b) exceeds a threshold, the UAV processing circuit 240 may change rotation speed of one or more of the motors 232 to change the flight characteristics of the UAV 100. For instance, the acceleration threshold may represent free fall. The rotation speed of all motors 232 may be throttled to maximum to maintain or gain elevation.

To synchronize the telemetry data determined by the EM system 200 with aspects of the UAV 100 controlled by the UAV processing circuit 240, timestamp, sequence numbers, and/or markers may be used for post-processing of the telemetry data. Markers may be digital input channels that can be plotted along with the telemetry data. The UAV processing circuit 240 can toggle a marker from low to high when an event occurs (e.g., at test start, test stop, malfunction detected, and the like). The marker event can be plotted alongside the telemetry data, showing exactly when the event occurred without the need of using timestamp synchronization. Through the use of timestamps, sequence numbers, and/or markers, the telemetry data may be matched to corresponding flight characteristics (or other aspects of the UAV 100) controlled by the UAV processing circuit 240 to allow convenient post-processing of data. In this manner correlation between the telemetry data and the flight characteristics (or other aspects of the UAV 100) can be readily accessible.

In some arrangements, the EM system 200 (e.g., the processing circuit 202) may be connected to the UAV processing circuit 240 to use the network device 236 to transmit the telemetry data to the base station 110 in real-time. In other arrangements, the EM system 200 (e.g., the processing circuit 202) may be operatively coupled to a dedicated network device 218 (separate from the network device 236) to transmit the telemetry data to the base station 110 in real-time.

While the various components of the UAV 100 are illustrated in FIGS. 2 and 3 as separate components, some or all of the components (e.g., the processor UAV processing circuit 240, the network device 236, the subsystems 220a, 220b, 320a, 320b, and 320c, and other components) may be integrated in a single device or module, such as a system-on-chip module.

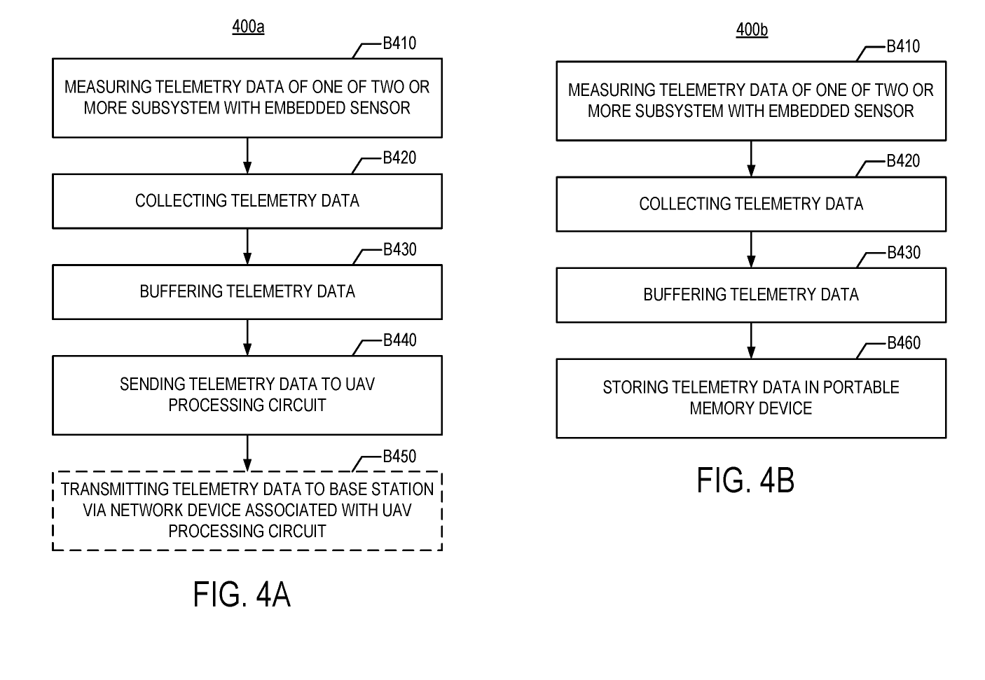

FIG. 4A is a flow diagram illustrating a method 400a for measuring the telemetry data using the EM system 200 (FIGS. 2 and 3) according to some implementations. Referring to FIGS. 1-4A, at block B410, the EM system 200 may measure the telemetry data of one of two or more subsystems (e.g., the subsystems 220a, 220b, 320a, 320b, and 320c) with embedded sensors (e.g., the sensors 214a, 214b, 314a, 314b, and 314c). The embedded sensors may be embedded in the one of two or more subsystems.

At block B420, the EM system 200 (e.g., the processing circuit 202) may collect the telemetry data measured with the embedded sensors. At block B430, the EM system 200 (e.g., the processing circuit 202) may buffer the telemetry data.

At block B440, the EM system 200 (e.g., the processing circuit 202) may send the telemetry data to the UAV processing circuit 240 via the bus 230. At block B450, the UAV processing circuit 240 may transmit the telemetry data to the base station 110 via the network device 236 associated with the UAV processing circuit 240 in some arrangements. In other arrangements, block B450 may not be performed.

FIG. 4B is a flow diagram illustrating a method 400b for measuring the telemetry data using the EM system 200 (FIGS. 2 and 3) according to some implementations. Referring to FIGS. 1-4B, the method 400b differs from the method 400a in that responsive to the EM system 200 (e.g., the processing circuit 202) buffering the telemetry data at block B430, the EM system 200 (e.g., the processing circuit 202) may store the telemetry data in the portable memory device 216, at block B460.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An embedded measurement (EM) system arranged on a robotic vehicle, comprising:
a processor; and
at least one sensor operatively coupled to the processor, each of the at least one sensor is embedded in a respective subsystem of the robotic vehicle to measure telemetry data thereof while the robotic vehicle is in transit.

2. The EM system of claim 1, wherein the telemetry data comprises one or more of power rail breakdown data, temperature, acceleration, or orientation.

3. The EM system of claim 1, wherein the at least one sensor comprises at least one first sense resister in series with a power rail of a first subsystem to measure power rail breakdown data of the first subsystem while the robotic vehicle is in transit.

4. The EM system of claim 3, further comprising:
a first differential ADC operatively coupled to the at least one first sense resister to measure voltage drop across the at least one first sense resistor.

5. The EM system of claim 3, wherein the at least one sensor comprises at least one second sense resister in series with a power rail of a second subsystem to measure power rail breakdown data of the second subsystem while the robotic vehicle is in transit.

6. The EM system of claim 5, further comprising:
a second differential ADC operatively coupled to the at least one second sense resister to measure voltage drop across the at least one second sense resistor.

7. The EM system of claim 1, wherein the at least one sensor comprises at least one thermocouple operatively coupled to a component of a subsystem of the robotic vehicle to measure temperature of the component while the robotic vehicle is in transit.

8. The EM system of claim 1, wherein the robotic vehicle is an unmanned aerial vehicle (UAV), and the telemetry data is measured while the UAV is in flight.

9. The EM system of claim 1, wherein the processing circuit of the EM is separate from a robotic vehicle processing circuit, wherein the robotic vehicle processing circuit is configured to control at least one of power or movement of the robotic vehicle.

10. The EM system of claim 9, wherein the processing circuit of the EM is operatively, via a communication bus, to the robotic vehicle processing circuit to provide the telemetry data to the robotic vehicle processing circuit for the robotic vehicle processing circuit to account for the telemetry data while the robotic vehicle is in transit.

11. The EM system of claim 10, wherein the telemetry data is synchronized between the processing circuit of the EM and the robotic vehicle processing circuit using one or more of timestamps, sequence numbers, or markers.

12. The EM system of claim 9, wherein the processing circuit of the EM is operatively coupled to the robotic vehicle processing circuit to transmit the telemetry data to a base station in real-time using a network device operatively coupled to the robotic vehicle processing circuit.

13. The EM system of claim 1, further comprising a memory interface configured to receive a portable memory device, wherein the processing circuit of the EM is configured to write the telemetry data to the portable memory device.

14. The EM system of claim 1, wherein the at least one sensor further comprises an acceleration sensor embedded in a subsystem to measure acceleration of the fourth subsystem.

15. The EM system of claim 1, wherein the at least one sensor further comprises an orientation sensor embedded in a subsystem to measure orientation of the fourth subsystem.

16. The EM system of claim 1, wherein the respective subsystem comprises two or more of a navigation subsystem, a flight control subsystem, a communication subsystem, a power subsystem, a camera subsystem, or an application processing subsystem.

17. An robotic vehicle, comprising:
a robotic vehicle processing circuit, comprising:
a robotic vehicle processor; and
a robotic vehicle memory;
two or more subsystems; and
an embedded measurement (EM) system, comprising:
at least one sensor, each of the at least one sensor is embedded in one of the two or more subsystems to measure telemetry data of the one of the two or more subsystems;
a processing circuit, comprising:
a processor operatively coupled to the at least one sensor to collect the telemetry data;
a memory operatively coupled to the processor, wherein the EM is configured to measure the telemetry data while the robotic vehicle is in transit.

18. The robotic vehicle of claim 17, wherein:
the at least one sensor comprises at least one first sense resister in series with a power rail of a first subsystem of the two or more subsystems to measure power rail breakdown data of the first subsystem while the robotic vehicle is in transit; and
the EM system further comprises a first differential ADC operatively coupled to the at least one first sense resister to measure voltage drop across the at least one first sense resistor.

19. The robotic vehicle of claim 18 wherein:
the at least one sensor comprises at least one second sense resister in series with a power rail of a second subsystem of the two or more subsystems to measure power rail breakdown data of the second subsystem while the robotic vehicle is in transit; and
the EM system further comprises a second differential ADC operatively coupled to the at least one second sense resister to measure voltage drop across the at least one second sense resistor.

20. The robotic vehicle of claim 17, wherein the at least one sensor comprises at least one thermocouple operatively coupled to a component of a third subsystem of the robotic vehicle to measure temperature of the component while the robotic vehicle is in transit.

21. The robotic vehicle of claim 17, wherein the at least one sensor further comprises an acceleration sensor embedded in a fourth subsystem of the two or more subsystems to measure acceleration of the fourth subsystem.

22. The robotic vehicle of claim 17, wherein the at least one sensor further comprises an orientation sensor embedded in a fifth subsystem of the two or more subsystems to measure orientation of the fifth subsystem.

23. The robotic vehicle of claim 17, wherein the processing circuit of the EM is operatively coupled, via a communication bus, to the robotic vehicle processing circuit to provide the telemetry data to the robotic vehicle processing circuit for the robotic vehicle processing circuit to account for the telemetry data while the robotic vehicle is in transit.

24. The robotic vehicle of claim 17, wherein the telemetry data is synchronized between the processing circuit of the EM and the robotic vehicle processing circuit using one or more of timestamps, sequence numbers, or markers.

25. The robotic vehicle of claim 17, wherein the processing circuit of the EM is operatively coupled to the robotic vehicle processing circuit to transmit the telemetry data to a base station in real-time using a network device operatively coupled to the robotic vehicle processing circuit.

26. The robotic vehicle of claim 17, wherein the two or more subsystems comprise two or more of a navigation subsystem, a flight control subsystem, a communication subsystem, a power subsystem, a camera subsystem, or an application processing subsystem.

27. The robotic vehicle of claim 17, wherein the robotic vehicle processing circuit is configured to control at least one of the two or more subsystems.

28. An embedded measurement (EM) system arranged on robotic vehicle, comprising:
sensor means embedded in one of two or more subsystems of the robotic vehicle to measure telemetry data of the one of the two or more subsystems;
a processing circuit means, comprising:
a processing means operatively coupled to the sensor means to collect the telemetry data;
a memory means operatively coupled to the processing means, wherein the EM is configured to measure the telemetry data while the robotic vehicle is in transit.

29. A method for measuring telemetry data of a robotic vehicle using an embedded measurement (EM) system, comprising:
measuring, with at least one sensor, the telemetry data of one of the two or more subsystems of the robotic vehicle, wherein the at least one sensor is embedded in the one of two or more subsystems;
collecting, by a processing circuit of the EM system, the telemetry data;
buffering, by the processing circuit, the telemetry data; and
sending, by the processing circuit via a communication bus, the telemetry data to a robotic vehicle processing circuit.
